(19) United States
(12) Patent Application Publication
(10) Pub. No.: US 2009/0122424 A1
(43) Pub. Date: May 14, 2009

(54) Kitchenware magnifier

(76) Inventor: Marta Perez, Coral Gables, FL (US)

Correspondence Address: RUBEN ALCOBA, ESQ., 3399 NW 72 AVENUE, SUITE211, MIAMI, FL, 33122, US

(21) Appl. No.: 11/983,940

(22) Filed: Nov. 13, 2007

(51) Int. Cl. G02B 25/00

(52) U.S. Cl. 359/809

(57) ABSTRACT

A kitchenware magnifying device comprising of a kitchen utensil and a magnifying element disposed within the kitchen utensil. The kitchenware magnifying device is used to read labels or other written materials.

### BACKGROUND

The present invention is directed to magnifying devices, more specifically, to kitchenware having a magnifying element therein. The invention is to be used in household kitchens by people wishing to read labels or other items within a kitchen.

All kitchens have many items that have to be read, e.g., cookbooks or labels on food packaging, medicines, or vitamins. Most labels are written in small fonts and are very difficult to see.

The inventor realized that she was having difficulties seeing the labels in her kitchen. She had magnifying glasses and other devices to help her see small items, yet often she would misplace the glasses or devices. The inventor realized that she had to develop kitchenware magnifying devices that would remain in the kitchen.

She reasoned that the kitchenware magnifying devices had to be existing prominent fixtures in the kitchen. She did not want the devices to be items that could be moved from one room to another, for then the devices would eventually become misplaced.

Information relevant to address the problem of having to use devices to read labels or small print on items has been addressed in U.S. Pat. Nos. 5,065,373, 6,950,374 B2, and 6,532,117 B2. However, each one of these references suffers from one or more of the following disadvantages: The devices can be misplaced or never be in the kitchen when needed.

For the foregoing reasons, there is a need for kitchenware magnifying devices that are common fixtures in a kitchen, that allow users to read small print on labels or other reading materials, and that are not easily misplaced.

### SUMMARY

The present invention is directed to kitchenware magnifying devices that satisfy the need of having magnifying devices that are a common fixtures in a kitchen, that allow users to read small print on labels or other reading materials, and that are not easily misplaced. The embodiments of the present invention discloses items of kitchenware that include a magnifying element. More particularly, the embodiments are soap holders and serving spoon holder.

In one particular embodiment, the kitchenware magnifying device is a soft soap housing which houses a disposable bottle of soft soap, a hinged door attached to the housing, and a magnifying glass attached to the hinged door. The housing has a top, bottom, first, second, third and fourth side. The top side defines a hole wherein a disposable bottle of soap can be inserted, the first three sides are permanently attached to the bottom and the top sides, the fourth side is a hinged door that is attached to the third side. The hinged door defines a hole somewhere within the hinged door and a magnifying glass is disposed within the hole and is attached to the hinged door.

In another embodiment of the present invention, the kitchenware device is a bar of soap holder magnifying device. The bar of soap holder magnifying device comprises a base, the base defines a depression wherein a bar of soap is placed, and a perpendicular wall attached to one of the sides of the base, the wall defines a hole somewhere within the perpendicular wall, and a magnifying element disposed within the hole of the perpendicular wall and attached to the perpendicular wall.

In yet another embodiment of the present invention, the kitchenware device is a serving spoon holder magnifying device. The serving spoon holder magnifying devices comprises a serving spoon holder, the serving spoon holder defining a hole somewhere within the spoon holder, and a magnifying glass disposed within the hole of the spoon holder and attached to the spoon holder.

The bottle of soap holder magnifying device is used by opening the door of the device and placing the magnifying element of the door over any text that is to be read.

The bar of soap holder device is used by placing the magnifying element over any text that is to be read.

The serving spoon holder magnifying device is used by placing the magnifying element over any text that is to be read.

What follows are some of but not all, the objects of this invention. In addition to the specific objects stated below for at least some preferred embodiments of the invention, other objects and purposes will be readily apparent to one of skill in this art that has the benefit of this invention's teachings and disclosures. It is therefore, an object of at least some preferred embodiments of the present invention to provide:

An object of the present invention is to provide kitchenware magnifying devices that will be fixtures within a kitchen.

Another object of the present invention is to provide kitchenware magnifying devices that will allow users to see labels or other reading materials in a kitchen.

Yet another object of the present invention is to provide kitchenware magnifying devices that are easily located.

### DRAWINGS

These and other features, aspects, and advantages of the present invention will become better understood with regard to the following description, appended claims, and drawings where:

FIG. 1 shows a perspective view of a disposable bottle of soap holder magnifying device;

FIG. 2 shows another perspective view of the disposable bottle of soap holder magnifying device with a door open;

FIG. 3 shows a perspective view of a bar of soap holder magnifying device;

FIG. 4 shows a top view of serving spoon holder magnifying device, wherein the magnifying element is disposed within the arm of the spoon holder;

FIG. 5 shows a side view of serving spoon holder magnifying device; and

FIG. 6 shows a perspective view of serving spoon holder magnifying device, wherein the magnifying element is disposed within the arm of the serving spoon holder.

### DESCRIPTION

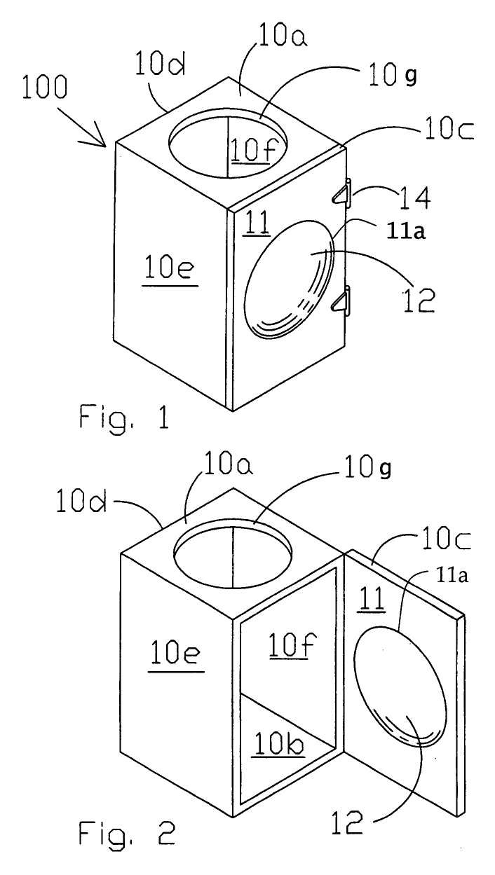

FIGS. 1-6 show embodiments of kitchenware magnifying devices according to the present invention that comprises a kitchen utensil and a magnifying element disposed within the kitchen utensil.

FIGS. 1 and 2 show an embodiment of the kitchenware magnifying device 100. The embodiment is a soft soap housing 100 comprising a housing 10 which houses a disposable bottle of soft soap, a hinged door 11 attached to the housing 10, and a magnifying element 12 attached to the hinged door 11. The housing 10 has a top 10a, bottom 10b, first 10e, second 10d, third 10f, and fourth 10c side. The top side 10a defines a hole 10g wherein a disposable bottle of soap can be inserted, the first three sides 10 d-f are permanently attached to the bottom 10b and the top 10a sides, the fourth side 10c/11 is a hinged door 11 that is attached to the third side 10f. The hinged door 11 defines a hole 11a somewhere within the hinged door 11 and a magnifying element 12 is disposed within the hole 11a and is attached to the door 11.

The bottle of soap holder magnifying device is used by opening the door of the device and placing the magnifying element of the door over any text that is to be read.

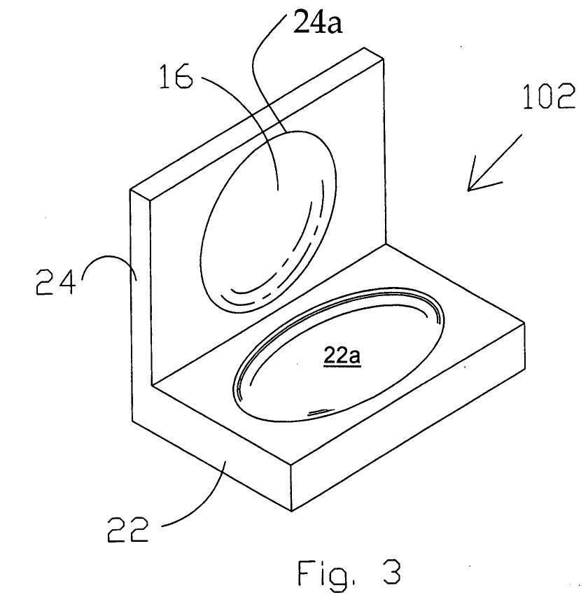

FIG. 3 shows another embodiment of the kitchenware magnifying device according to the present invention wherein the device is a bar of soap holder magnifying device 102. The bar of soap holder magnifying device 102 comprises a base 22, the base 22 defines a depression 22a wherein a bar of soap is placed, and a perpendicular wall 24 attached to one of the sides of the base 22, the wall 24 defines a hole 24a somewhere within the perpendicular wall, and a magnifying element 16 disposed within the hole 24a of the perpendicular wall 24 and attached to the perpendicular wall 24.

The bar of soap holder device 102 is used by placing the magnifying element 16 over any text that is to be read.

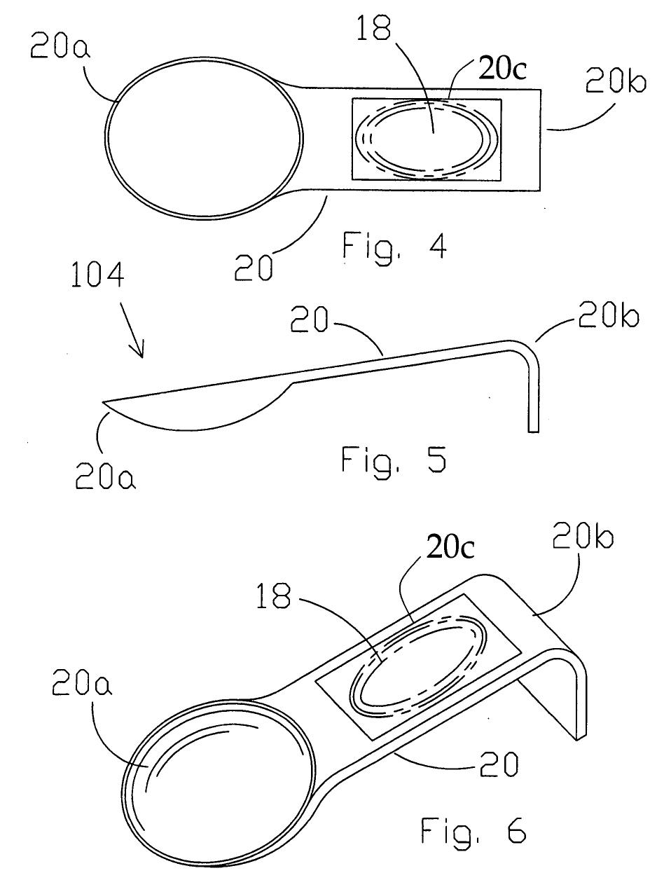

FIGS. 4-6 show further embodiment of the kitchenware magnifying device according to the present invention wherein the device is a serving spoon holder magnifying device 104. The serving spoon holder 104 comprises a serving spoon holder 20, the serving spoon holder defines a hole 20c somewhere within the spoon holder 20, and a magnifying element 18 disposed within the hole 20c of the spoon holder 20 and attached to the spoon holder 20.

The serving spoon holder magnifying device 104 is used by placing the magnifying element 18 over any text that is to be read.

The magnifying element in all of the aforementioned embodiments may be a lens of any desired width and of any desired magnification strength.

An advantage of the present invention is that it provides kitchenware magnifying devices that are fixtures within a kitchen.

Another advantage of the present invention is that it provides kitchenware magnifying devices that allow users to see labels or other reading materials in a kitchen.

Yet another advantage of the present invention is that it provides kitchenware magnifying devices that are easily located.

Although the present invention has been described in considerable detail with reference to certain preferred versions thereof, other versions are possible. Therefore, the spirit and the scope of the claims should not be limited to the description of the preferred versions contained herein.

What is claimed is:

1. A kitchenware magnifying device comprising:
a kitchen utensil; and
a magnifying element disposed within the kitchen utensil.

2. The device of claim 1, wherein the kitchen utensil is a soft soap housing, comprising:
a housing which houses a disposable bottle of soft soap, the housing has a top, bottom, first, second, third, and fourth side, the top side defines a hole wherein a disposable bottle of soap can be inserted, the first three sides are permanently attached to the bottom and the top sides; and
a hinged door attached to the housing's third side, the hinged door defines a hole somewhere within the hinged door and the magnifying element is disposed within the hole and is attached to the hinged door.

3. The device of claim 1, wherein the kitchen utensil is a bar of soap holder, comprising:
a base, the base defines a depression wherein a bar of soap is placed; and
a perpendicular wall attached to one of the sides of the base, the wall defines a hole somewhere within the perpendicular wall, and the magnifying element is disposed within the hole and is attached to the perpendicular wall.

4. The device of claim 1, wherein the kitchen utensil is a spoon holder, wherein the spoon holder defines a hole somewhere within the spoon holder, and the magnifying element is disposed within the hole and is attached to the spoon holder.
